(19) United States
(12) Patent Application Publication
(10) Pub. No.: US 2009/0153584 A1
(43) Pub. Date: Jun. 18, 2009

(54) IMAGE ADJUSTING APPARATUS

(75) Inventors: Feng-Jia Liu, Taipei County (TW); Chun-Ming Cheng, Taipei County (TW); Tsung-Hsiang Huang, Changhua County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: PRINCETON TECHNOLOGY CORPORATION, Taipei County (TW)

(21) Appl. No.: 12/044,021

(22) Filed: Mar. 7, 2008

(30) Foreign Application Priority Data
Dec. 13, 2007 (TW) 96221186

(51) Int. Cl. G09G 5/00

(52) U.S. Cl. 345/617

(57) ABSTRACT

An image adjusting apparatus is provided for adjusting the contrast of an input image. The image adjusting apparatus comprises a transformation module, a memory module, a processing module, an output module and a display module. The transformation module is used for transforming the input image to a plurality of input image values. The memory module is used for pre-storing a plurality of gain curves, wherein each of the gain curves comprises at least one first segment with a first slope and one second segment with a second slope. The processing module is coupled to the transforming module and the memory module for adjusting the plurality of the input image values and generating a plurality of output image values corresponding thereto according to a gain curve. The output module is coupled to the processing module for generating an output image according to the plurality of the output image values. The display module is coupled to the output module for displaying the output image.

### BACKGROUND OF THE INVENTION

1. Field of the Invention

The invention relates to an image adjusting apparatus, and more particularly, to an image adjusting apparatus for adjusting the contrast of an image.

2. Description of the Related Art

Existing display technologies can be divided into a first type using displays with a backlight module providing a light source and a second type using displays that produces its own light. For a conventional liquid crystal display (LCD), brightness is provided by a backlight module therewith in which twisting of the crystal displays are controlled to change the transmissivity of the backlight so as to determine brightness of an image. A field emission display (FED) is an emissive display that produces its own light in which electrons with high energy are illuminated on image mediums (pixels) of a phosphor screen for emitting light and the electronic energy of the excited phosphors materials are then converted to visible lights. The FEDs are energy efficient and consume less power versus existing LCDs such that FEDs are becoming one of the more popular displays demanded.

Histogram equalization, however, is a method whereby the contrast of the image is increased by contrast adjustment of conventional image play apparatuses using an image's histogram. When acquiring the brightness histogram of an image, a brightness transformation function is determined based on information of the acquired histogram, wherein the brightness transformation function is utilized to adjust the contrast of the image so as to achieve better image quality. The basic concept of histogram equalization is to assign a large range of grayscale values to a higher grayscale value in the histogram. Disadvantages of this method are that a portion of the image contrast may be lost and the contrast of un-wanted background noise may be increased, while resulting in an unnatural final image.

FIG. 1 is a schematic illustrating a brightness transformation function for use in conventional contrast adjusting. As shown in FIG. 1, for contrast adjustment of an image, a characteristic curve of the transformation function with a gain value 1 may be applied to adjust input images (i.e. the input image is outputted directly by the display apparatus without performing any image adjusting) or characteristic curves of the transformation function with the same gain value (e.g. a characteristic curve of the transformation function with a gain value 0.8 or a gain value 1.2) may be applied to adjust input images. However, when above-mentioned method is applied to adjust the contrast of the image, since gain used in adjusting each image value is equivalent, the portion of the input image with low brightness image value will be adjusted accordingly and the portion of the input image with high brightness image value is adjusted, resulting in an output image with unobvious contrast. As a result, performance of adjusting the contrast of the image will be significantly reduced and thus accordingly the quality of the output image will also be reduced.

The aforementioned problem may be unobvious when a display with a backlight module to provide a light source is utilized. This problem, however, will be obvious and easy to be found by the user if a display that produces its own light, such as a FED, is utilized.

It is therefore a need to provide an image adjusting apparatus capable of exactly adjusting the contrast of the image so as to obtain better image quality of the output image.

### BRIEF SUMMARY OF THE INVENTION

The embodiments of the invention provide an image adjusting apparatus for adjusting the contrast of an input image so as to solve the aforementioned problems with conventional image play apparatuses.

In one embodiment, an image adjusting apparatus is provided. The image adjusting apparatus comprises a transformation module, a processing module, an output module and a display module. The transformation module is used for transforming the input image to a plurality of input image values. The processing module is coupled to the transforming module for adjusting the plurality of the input image values and generating a plurality of output image values corresponding thereto according to a gain curve. The output module is coupled to the processing module for generating an output image according to the plurality of the output image values. The display module is coupled to the output module for displaying the output image.

### BRIEF DESCRIPTION OF THE DRAWINGS

The invention can be more fully understood by reading the subsequent detailed description and examples with reference to the accompanying drawings, wherein:

FIG. 1 is a schematic illustrating a brightness transformation function used for conventional contrast adjusting;

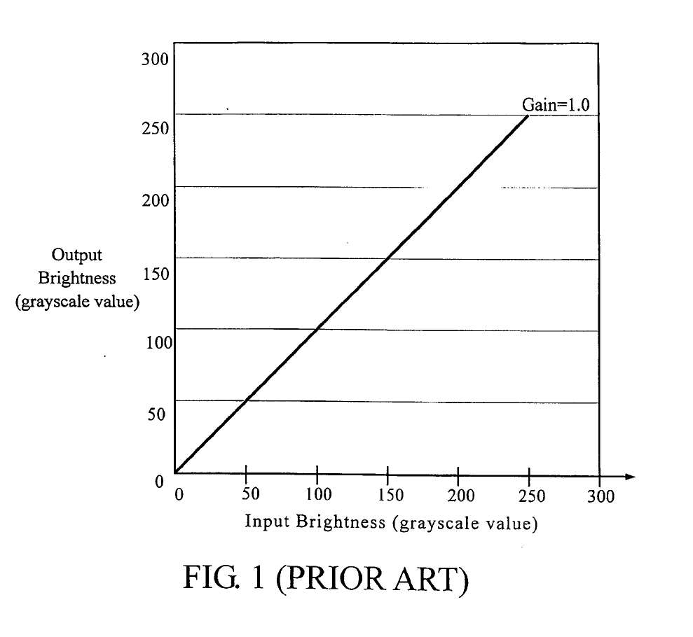

FIG. 2 shows an embodiment of an image adjusting apparatus according to the invention;

FIG. 3 is a schematic showing a gain curve of the invention; and

FIG. 4 is a schematic showing the gain curve C1 of FIG. 3.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

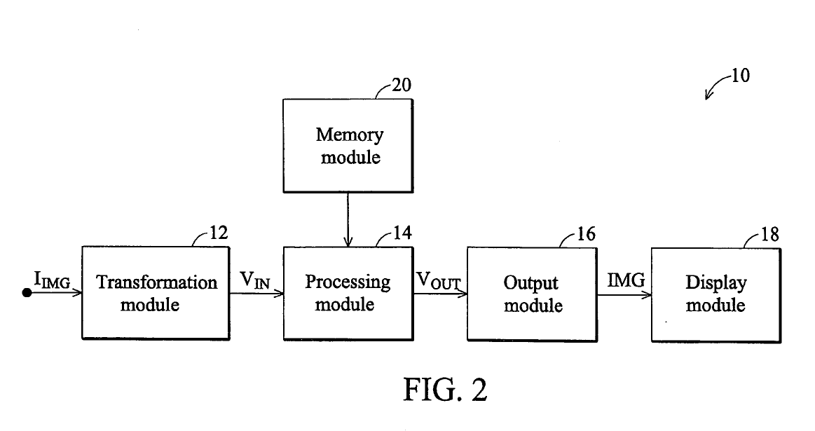

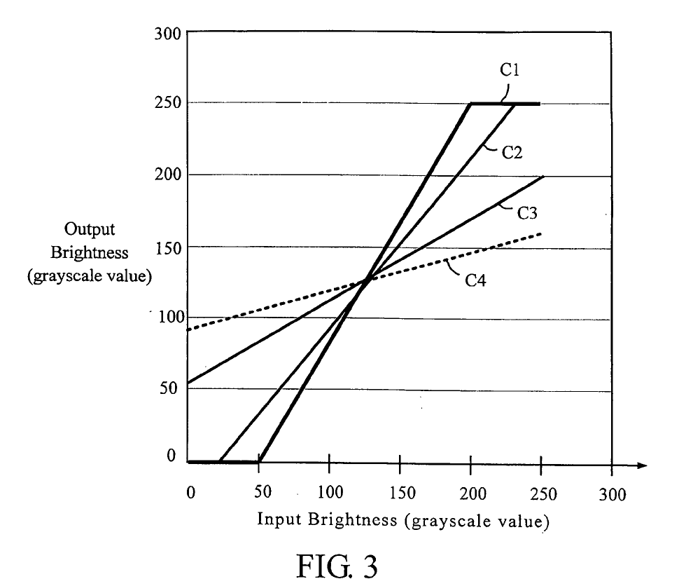

Please refer to FIGS. 2 and 3. FIG. 2 shows an embodiment of an image adjusting apparatus according to the invention. FIG. 3 is a schematic showing a gain curve of the invention. As shown in FIG. 2, in this embodiment, an image adjusting apparatus 10 is disclosed for adjusting the contrast of an input image I_{IMG}. The image adjusting apparatus 10 comprises a transformation module 12, a processing module 14, an output module 16 and a display module 18. The transformation module 12 is used for transforming the input image I_{IMG} to a plurality of input image values V_{IN}. The processing module 14 is coupled to the transforming module 12 for adjusting the input image values V_{IN} and generating a plurality of output image values V_{OUT} corresponding thereto according to a gain curve. The output module 16 is coupled to the processing module 14 for generating an output image IMG according to the generated output image values V_{OUT}. The display module 18 is coupled to the output module 16 for displaying the output image IMG. In one embodiment, the display module 18 may be a field emission display (FED).

The transformation module 12 is used for transforming the input image I_{IMG} to the input image values V_{IN} with a specific image format. In one embodiment, the specific image format is a YCbCr image format. In addition, the image adjusting apparatus 10 further comprises a memory module 20 coupled to the processing module 14 for pre-storing a plurality of gain curves C1-C4. The processing module 14 adjusts the input image values V_{IN} and generates the output image values V_{OUT} corresponding thereto based on one of the gain curves C1-C4.

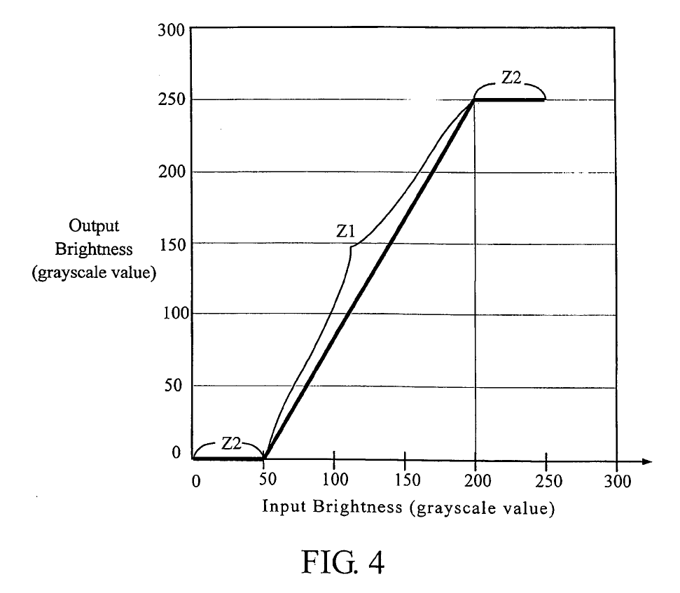

Please refer to FIGS. 3 and 4. FIG. 4 is a schematic showing the gain curve C1 of FIG. 3. As shown in FIGS. 3 and 4, in one embodiment, each of the gain curves C1-C4 comprises at least one first segment Z1 and one second segment Z2 in which the first segment Z1 is between first brightness value Y1 and second brightness value Y2 and the second segment Z2 is greater than the first brightness value Y1 or less than the second brightness value Y2. The first brightness value Y1 exceeds the second brightness value Y2. The first segment Z1 has a first slope and the second segment Z2 has a second slope in which the first slope represents a first gain value and the second slope represents a second gain value. When the image values within the input image values V_{IN} are values between the first brightness value Y1 and the second brightness value Y2, the processing module 14 adjusts the image value based on the first gain value of the gain curve. When the input image values V_{IN} are greater than the first brightness value Y1 or less than the second brightness value Y2, the processing module 14 adjusts the image value based on the second gain value of the gain curve.

Referring again to FIG. 4, the gain curve C1 is utilized as an example for illustrating related operations whereby the processing module 14 adjusts the input image values V_{IN} and further generates output image value V_{OUT}. First, the first brightness value, the second brightness value, the first gain value and the second gain value within the gain curve C1 are predefined as grayscale value 200, grayscale value 50, 1.67 and 0, respectively. The processing module 14 will adjust image values with values between grayscale values 50 and 200 (such as image values within the first segment Z1 shown in FIG. 4) to output image values V_{OUT} with a gain value 1.67 that was 1.67 times its original image value and then output the output image values V_{OUT}. Similarly, image values with values greater than the first brightness value (grayscale value 200) and less than the second brightness value (grayscale value 50) (such as image values within the first segment Z2 shown in FIG. 4) will be adjusted to output image values V_{OUT} with a gain value 0 that was zero times its original image value and then output the output image values V_{OUT}. With the above-mentioned method, the input image values V_{IN} can be adjusted to the output image values V_{OUT}.

In another embodiment, the memory module 20 further comprises a look-up table (not shown) in which the look-up table comprises the gain curves C1-C4 and a plurality of output image values V_{OUT} corresponding to each input image value V_{IN} of each gain curve. The processing module 14 adjusts the input image values V_{IN} and generates output image values V_{OUT} corresponding thereto according to the gain curves C1-C4 within the look-up table. In this embodiment, the output image values V_{OUT} are obtained by looking up the look-up table and the obtained output image values V_{OUT} are further provided to the output module 16 for generating the output image IMG.

In the embodiments of the invention, the image adjusting apparatus adjusts the contrast of the same input image with different gain values such that an output image generated by the disclosed image adjusting apparatus can have better image contrast, significantly improving the image quality of the output image.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. An image adjusting apparatus for adjusting the contrast of an input image, comprising:
a transformation module, transforming the input image to a plurality of input image values;
a memory module for pre-storing a plurality of gain curves, wherein each of the gain curves comprises at least one first segment with a first slope and one second segment with a second slope;
a processing module coupled to the transforming module and the memory module, adjusting the plurality of the input image values and generating a plurality of output image values corresponding thereto according to a gain curve;
an output module coupled to the processing module, generating an output image according to the plurality of the output image values; and
a display module coupled to the output module, displaying the output image;
wherein the processing module adjusts the plurality of the input image values and generates the plurality of the output image values corresponding thereto according to one of the plurality of the gain curves.

2. The image adjusting apparatus as claimed in claim 1, wherein the transformation module is used for transforming the input image to the plurality of the input image values with a specific image format.

3. The image adjusting apparatus as claimed in claim 2, wherein the specific image format is a YCbCr image format.

4. The image adjusting apparatus as claimed in claim 1, wherein the display module is a field emission display (FED).

5. The image adjusting apparatus as claimed in claim 1, wherein the first slope represents a first gain value and the second slope represents a second gain value.

6. The image adjusting apparatus as claimed in claim 5, wherein the first segment is between a first brightness value and a second brightness value and the second segment is greater than the first brightness value or less than the second brightness value.

7. The image adjusting apparatus as claimed in claim 6, wherein the processing module adjusts the image value based on the first gain value of the gain curve when the image values within the plurality of the input image values are values between the first and second brightness values.

8. The image adjusting apparatus as claimed in claim 7, wherein the processing module adjusts the image value based on the second gain value of the gain curve when the plurality of the input image values exceed the first brightness value.

9. The image adjusting apparatus as claimed in claim 7, wherein the processing module adjusts the image value based on the second gain value of the gain curve when the plurality of the input image values are less than the second brightness value.

10. The image adjusting apparatus as claimed in claim 8, wherein the first brightness value is less than the second brightness value.

11. The image adjusting apparatus as claimed in claim 1, wherein the memory module further comprises a look-up table having the plurality of gain curves and a plurality of output image values corresponding to each input image value of each gain curve.

12. The image adjusting apparatus as claimed in claim 11, wherein the processing module adjusts the plurality of the input image values and generates output image values corresponding thereto according to the plurality of the gain curves of the look-up table.
